(19) United States
(12) Patent Application Publication
(10) Pub. No.: US 2026/0094387 A1
(43) Pub. Date: Apr. 2, 2026

(54) TRIAGE WITH REAL-TIME 3D IMAGE PROJECTION ON A MIXED REALITY HEADSET

(71) Applicant: BRIGHTERMD LLC, Plano, TX (US)

(72) Inventors: Jesse Ohayon, Plano, TX (US); Mikayla Ohayon, Plano, TX (US)

(21) Appl. No.: 18/902,196

(22) Filed: Sep. 30, 2024

(51) Int. Cl. G06T 19/00; G02B 27/01; G06T 7/70

(52) U.S. Cl. CPC G06T 19/006; G02B 27/017; G06T 7/70; G02B 2027/0174

(57) ABSTRACT

Triage determination is made for a patient via real-time three dimensional (3D) image projection from an image capture device at the geographic location of the patient to a mixed reality headset worn by a medical professional at second geographic location that is remote relative to the geographic location of the patient. With a real-time communication established between the image capture device of the patient and the headset of the medical professional, the medical professional views streaming 3D detail of the captured 2D images of the patient, or a part of the patient’s body, and triage determination can be transmitted in real-time from the headset to the image capture device for remote triage of the patient in real-time.

### FIELD OF THE DISCLOSURE

The present disclosure relates to the triage of a patient where the patient is in a location that is remote from the location of the medical professional. More particular, the disclosure relates to triage with real-time 3D image projection on an mixed reality headset.

### BACKGROUND

Workers can be injured at a worksite. Safety procedures can be followed to stop the work around the worker and move the injured worker to a safe location for assessment of the situation. It is often the case that medical professionals are not on the worksite, and it is the worker, another worker, or a manager that triages the severity of the injury of the worker at the worksite and determines a next step for treatment of the injury.

Many safety procedures default to calling an emergency service, e.g., 9-1-1 in the United States. However, this safety procedure can classify many types of injuries–that are not emergencies—as an emergency. The injured worker, now a patient, is treated at an emergency level care no matter the severity of the injury. This can lead to financial and time resources expended on injuries that are not emergencies.

With the advent of telemedicine, injured workers can be connected remotely with a medical professional, for example, via computer devices that have a camera, microphone, and capability to exchange photos, audio, or video between the injured worker and the medical professional. The exchanged photos and video are two-dimensional, and the medical professional still must make a triage determination based on two dimensional images presented to the medical professional.

### SUMMARY

A streaming triage system can include: an image capture device; and a mixed reality headset networked in a two-way live stream with the image capture device,

wherein the image capture device: captures, in real-time, 2D images of a patient; determines, in real-time with capture, device positional data of the image capture device for each of the 2D images; encodes, in real-time, the 2D images and the device positional data into an encoded data stream; transmits, in real-time to the mixed reality headset, the encoded data stream; and receives, in real-time from the mixed reality headset, a triage determination;

wherein the mixed reality headset: receives, in real-time from the image capture device, the encoded data stream; converts, in real-time, the 2D images received in the encoded data stream to 3D images; converts, in real-time, the device positional data for the image capture device received in the encoded data stream into headset positional data for the mixed reality headset; projects, in real-time, a holographic representation of the 3D images in a headset 3D space based on the headset positional data; and sends, in real-time to the image capture device, a triage determination. The patient is triaged by a medical professional wearing the mixed reality headset in real-time.

A method can include: capturing, in real-time by an image capture device, 2D images of a patient; determining, in real-time by the image capture device, a device positional data of the image capture device corresponding to each of the 2D images, wherein the device positional data is defined relative to a patient 3D coordinate system in a patient 3D space; encoding, in real-time by the image capture device, the 2D images and the device positional data into an encoded data stream; transmitting, in real-time by the image capture device to a mixed reality headset, the encoded data stream including the 2D images of the patient and the device positional data of the image capture device for each of the 2D images; and receiving, by the image capture device from the mixed reality headset, a triage determination.

A method can include: receiving, by a mixed reality headset from an image capture device, an encoded data stream, wherein the encoded data stream includes 2D images of a patient and a device positional data of the image capture device for each of the 2D images; converting, in real-time by the mixed reality headset, the 2D images received in the encoded data stream to 3D images; converting, in real-time by the mixed reality headset, the device positional data for the image capture device received in the encoded data stream into headset positional data for the mixed reality headset, wherein the headset positional data is defined relative to a headset 3D coordinate system in a headset 3D space; projecting, in real-time by the mixed reality headset, a holographic representation of the 3D images in the headset 3D space based on the headset positional data; and sending, in real-time by the mixed reality headset, a triage determination to the image capture device.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of a system for triage with real-time 3D image projection having an image capture device and a mixed reality headset.

FIG. 2 illustrates a method performed by the image capture device.

FIG. 3 illustrates a method performed by the mixed reality headset.

FIG. 4 illustrates a patient 3D space established using the image capture device.

FIG. 5 illustrates a headset 3D space established using the mixed reality headset.

### DETAILED DESCRIPTION

“Patient” as used herein refers to the person that is triaged using the system, methods, and devices disclosed herein.

“Triage” as used herein refers to an assessment of a condition of a patient.

“Medical professional” can include any medical professional that can triage a patient, such as a medical doctor, a registered nurse, a physician assistant, or a combination thereof.

The terms “real-time” and “live” are interchangeable, and each can refer to the actual time during which a triage of a patient occurs. In “real-time” and “live” include any delays inherent in data transmission between two devices, such as network infrastructure delays caused by distance and/or network hardware, inter-network jumps, etc.

The term “stream” and its variants used as noun and verb herein include the continuous transmission of data between two devices, such as the image capture device and mixed reality headset disclosed herein. A real-time stream or live stream includes a stream that occurs in real time relative to the triage event.

The term “two-dimensional” can be abbreviated 2D and can refer to two physical dimensions that form a plane, such as X and Y, X and Z, or Y and Z dimensions in a given 3D space.

The term “three-dimensional” can be abbreviated 3D can refer to three physical dimensions, namely, X, Y, and Z dimensions in a given 3D space.

As used herein, the term “hologram,” “holographic projection,” or “holographic representation” refer to a computer-generated image projected by a mixed reality headset disclosed herein, that is based on the 2D images captured by the image capture device that are real images of the patient captured in two-dimensions by the image capture device and rendered in three-dimensions by the mixed reality headset.

The disclosed system, methods, and devices allow medical professionals to make a triage determination for a patient via real-time three dimensional (3D) image projection from an image capture device at the location of the patient to a mixed reality headset worn by the medical professional at second location that is remote relative to the location of the patient. With a real-time communication established between the image capture device of the patient and the headset of the medical professional, the medical professional views a 3D image of the patient’s body, or part of the patient’s body, and provides triage determination to the image capture device for treatment of the patient in real-time. Triage of patients is improved because the 3D images provide more context for the medical professional to assess the status of the patient.

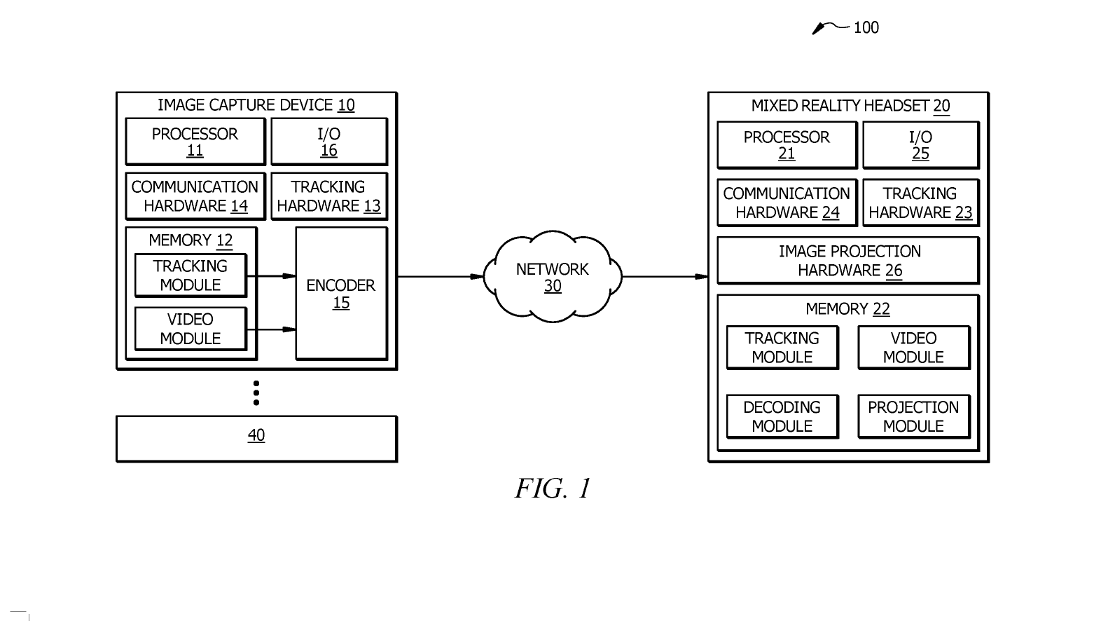

FIG. 1 illustrates a schematic diagram of a system 100 for triage with real-time 3D image projection. The system 100 has an image capture device 10 and a mixed reality headset 20 networked with the image capture device 10 via network 30. The system 100 can also include a position correction device 40 networked with the image capture device 10. The network 30 can include any one or combination of a wired internet connection, wireless internet connection, local area network (LAN), wired intranet connection, wireless intranet connection, or combinations thereof. The network 30 can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), etc. The image capture device 10 and position correction device 40 can be networked via a wired internet connection, wireless internet connection, local area network (LAN), wired intranet connection, wireless intranet connection, or combinations thereof. Examples of the connection between the position correction device 40 and the image capture device 10 can include a Wi-Fi or Bluetooth.

The image capture device 10 can be embodied as a smart phone, tablet, laptop, PC, or other computer device having a camera and capability for streaming video (e.g., 2D images and audio) captured by and device positional data determined by the image capture device 10 to the mixed reality headset 20 disclosed herein. Commercially available smart devices include those manufactured by Apple, Samsung, Google, and Huawei. In aspects, the image capture device 10 can also be a device similar to commercially available smart devices, and having additional software and/or hardware for the encoding that is described herein. The image capture device 10 can have a processor 11, a memory 12 having instructions stored thereon for execution by the processor 11, tracking hardware 13, communication hardware 14, encoder 15, and input/output 16.

The processor 11 of the image capture device 10 can be one or more processors suitable for performing the method and functionality disclosed herein for the image capture device 10.

The memory 12 of the image capture device 10 can have and one or more software programs configured to execute the method steps disclosed herein that are performed by the image capture device 10. For example, the memory 12 can have a tracking module for interacting with the tracking hardware 13 to determine the positional data for the image capture device 10 and a video module for interacting with the camera of the communication hardware 14 to capture the 2D images of the patient.

The tracking hardware 13 can include one or more of a geographic position device, an accelerometer, a gyroscope, and a magnetometer. The geographic position device can be configured to send/receive/use global positions system (GPS) or global navigation satellite system (GNSS) signals to determine a geographic location or position of the image capture device 10. The tracking hardware 13 can be controlled by the tracking module in the memory 12.

In aspects, the tracking hardware 13 determines the geographic location or position of the image capture device 10 in real-time while establishing a 3D space in which the patient 3D coordinate system is applied.

In aspects, the tracking hardware 13 determines the geographic location or position of the image capture device 10 in real-time during the image capture so as to record the geographic location or position of the image capture device 10 for every 2D image that is captured by the image capture device 10.

The communication hardware 14 can include any display, camera, microphone, and speaker that can be included with a smart phone, tablet, laptop, PC, or other computer device having a camera and capability for streaming 2D images captured by the device to the mixed reality headset 20. The communication hardware 14 can be controlled by the video module in the memory 12.

The encoder 15 can be configured as a multi-channel encoder (e.g., having at least two-channels) to receive a stream of device positional data from the tracking module and a stream of 2D images from the video module. The encoder 15 is further configured to encode the received stream of 2D images and the received stream of device positional data into an encoded data file/stream/packet, by for example, compressing and attaching the relevant positional data to each of the 2D images, and sending the encoded data/stream/packet (e.g., encoded data, encoded data stream, encoded data packet) to the input/output 16. In aspects, the encoded data can be sent to the input/output 16 in form of an encoded data stream that is continuously streamed from the encoder 15 to the input/output 16. In aspects, the format of the encoded data/stream/packet can be key-length-value (KLV) format.

The input/output 16 (labeled as “I/O” in FIG. 1) can be a wireless transceiver embodied as any transmitter and receiver configured to receive and send wireless data between the image capture device 10 and the mixed reality headset 20 as described herein. The input/output 16 can be configured to receive the encoded data from the encoder 15 and transmit an encoded data stream to the mixed reality headset 20. The input/output 16 can also be configured to receive a real-time video stream or real-time audio stream from the mixed reality headset 20, which is presented by the video module of the memory 12 on a display and/or speaker of the communication hardware 14 of the image capture device 10. In aspects in which position error correction is utilized, the input/output 16 can be configured to receive data via a wireless network connection (e.g., Bluetooth, Wi-Fi, NFC, or combinations thereof) from the position correction device 40 to receive position correction data. In some aspects, the position correction device 40 can send the position correction data via radio frequency signals (e.g., LoRa signals), and as such, the image capture device 10 can include radio frequency receiver hardware for receiving the radio frequency signals from the position correction device 40.

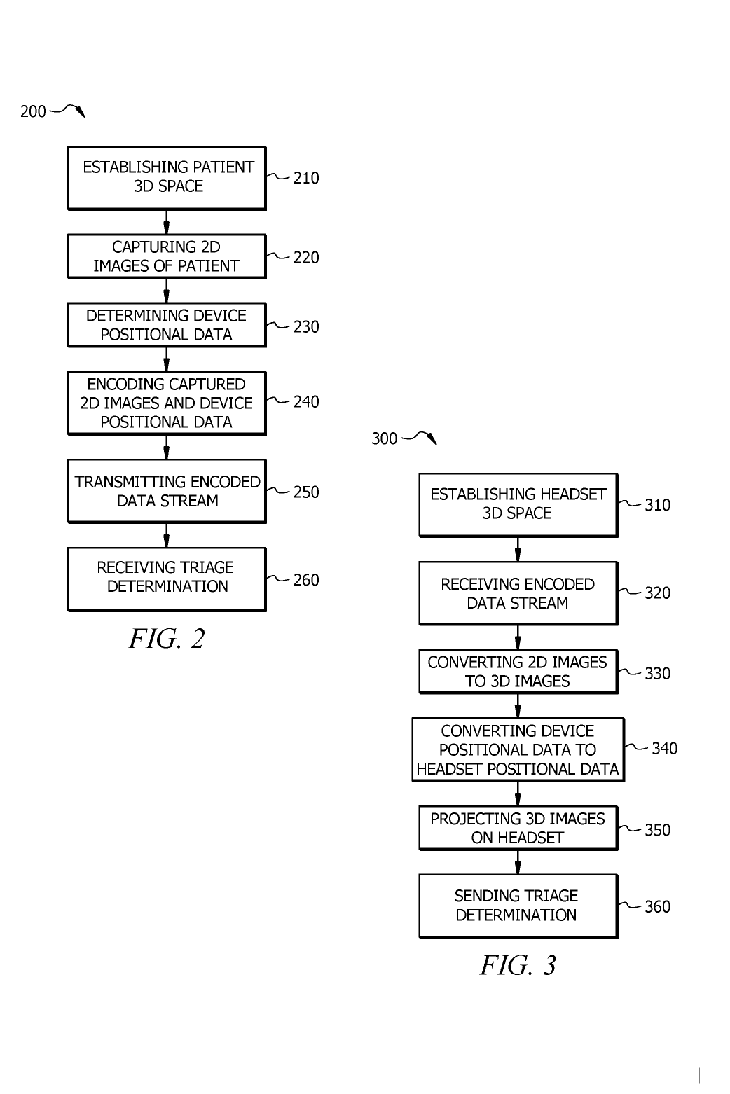

In some aspects, the instructions stored on the memory 12 can cause the processor 11 to perform one or more of the following functions (e.g., utilizing the tracking module and the video module): establish a patient 3D space; capture, in real-time, 2D images of a patient; determines, in real-time with capture, device positional data of the image capture device for each of the 2D images; encode, in real-time, the 2D images and the device positional data into an encoded data stream; transmits, in real-time to the mixed reality headset, the encoded data stream; receive, in real-time from the mixed reality headset, a triage determination; receive, from a position correction device 40 prior to capturing the 2D images of the patient, position correctional data; and apply, prior to capturing the 2D images, a correction to the geographic position of the image capture device 10 at each of the nodes that define the patient 3D space based on the position correctional data. In aspects, the device positional data for the image capture device 10 is defined relative to the patient 3D space. The functionality is described in more detail for the method 200 in FIG. 2.

The mixed reality headset 20 can be embodied as any headset device configured to be worn on the head of a medical professional for triage purposes described herein, that has one or more optical displays (such as lenses) that the medical professional can see into the headset 3D space in front of mixed reality headset 20, where the optical display(s) extend over and next to the eyes of the medical professional. An example of the mixed reality headset 20 is the Microsoft HoloLens programmed for the functionality described herein, or a headset similar to the Microsoft Hololens that additionally includes the hardware necessary to project the 3D images of the patient into the headset 3D space as described herein.

The processor 21 of the mixed reality headset 20 can be one or more processors suitable for performing the method and functionality disclosed herein for the mixed reality headset 20.

The memory 22 of the mixed reality headset 20 can have and one or more software programs configured to execute the method steps disclosed herein that are performed by the mixed reality headset 20. For example, the memory 22 can have a tracking module for interacting with the tracking hardware 23 to determine the positional data for the mixed reality headset 20, a video module for interacting with the camera of the communication hardware 24 and the input/output 25, a decoding module for interacting with the input/output 25 to decode the streamed encoded data and separate the decoded 2D images from the device positional data, and a projection module for converting the 2D images to 3D images, converting the device positional data to headset positional data and interacting with the image projection hardware 26 to project a stream of the 3D images (e.g., a holographic representation of the 3D images) of the patient on the display of the communication hardware 24 of the mixed reality headset 20.

The tracking hardware 23 can include one or more of a geographic position device, an accelerometer, a gyroscope, and a magnetometer. The geographic position device can be configured to send/receive/use global positions system (GPS) or global navigation satellite system (GNSS) signals to determine a geographic location or position of the mixed reality headset 20. The tracking hardware 23 can be controlled by the tracking module in the memory 22.

The communication hardware 24 can include any display, camera, microphone, and speaker that can be included with a mixed reality headset 20 having capability for real-time 3D image projection, or real-time holographic representation. The communication hardware 24 can be controlled by the video module in the memory 22.

The input/output 25 (labeled “I/O” in FIG. 1) can be a wireless transceiver embodied as any transmitter and receiver configured to receive and send wireless data between the image capture device 10 and the mixed reality headset 20 as described herein. The input/output 25 can also be configured to send a video stream or audio stream of the medical professional wearing the mixed reality headset 20 to the image capture device 10.

The image projection hardware 26 can be configured to project the holographic representation of the 3D images in the headset 3D space. The holographic representation is a stream of the 3D images projected in the headset 3D space. The orientation of the holographic representation is displayed by the image projection hardware 26 on the mixed reality headset 20 based on the headset positional data. Moreover, the image projection hardware 26 can scale the live projection of holographic representation of the 3D images based on the headset positional data to be consistent with the view captured by the image capture device 10 based on the device positional data.

The displayed holographic representation can appear to be stationary as the mixed reality headset 20 is moved around and through the headset 3D space. Alternatively, the displayed holographic representation of the 3D images can be displayed with augmented reality objects such as view control graphics that can be utilized to rotate, zoom, tilt, or otherwise manipulate the view displayed on the mixed reality headset 20 without physically moving the headset 20. Alternatively, the system 100 can further include one or more headset hand control devices may be used with the mixed reality headset 20 so that a user can rotate, zoom, tilt, or otherwise manipulate the view displayed on the mixed reality headset 20 without physically moving the headset 20. The headset hand control devices generally contain position sensors, buttons and wireless communication interface for communicating sensor position and the mixed reality headset 20 and headset hand control devices wirelessly couple for communication of position-related signals of the hand control devices to the headset. In aspects, the memory 22 of the mixed reality headset 20 may include hand tracking software such that the medical professional wearing the mixed reality headset 20 can rotate, zoom, tilt, or otherwise manipulate the view displayed on the mixed reality headset 20 with the user’s hand(s) without using headset hand control devices and without moving the mixed reality headset 20. An example of hand tracking software that can be stored as instructions in a memory for execution on the mixed reality headset 20 as disclosed herein is in U.S. Patent Application Publication No. 2017/0185141, which is incorporated by reference in its entirety.

In some aspects, the instructions stored on the memory 22 can cause the processor 21 to perform one or more of the following functions (e.g., utilizing the tracking module, the video module, the decoding module, the projection module, or a combination thereof): establish the headset 3D space; receives, in real-time from the image capture device, the encoded data stream; convert, in real-time, the 2D images received in the encoded data stream to 3D images; convert, in real-time, the device positional data for the image capture device received in the encoded data stream into headset positional data for the mixed reality headset; project, in real-time, a holographic representation of the 3D images in a headset 3D space based on the headset positional data; send, in real-time to the image capture device, a triage determination. The functionality is described in more detail for the method 300 in FIG. 3.

The position correction device 40 can be any device configured to determine geographic position error correction data and send the geographic position error correction data to the input/output 16 of the image capture device 10. For example, the position correction device 40 can have a GNSS receiver (e.g., a GNSS-RTK receiver), a wireless transceiver, a GNSS antenna (e.g., a GNSS L1/L2 surveying band antenna), a wireless antenna, one or more processors and one or more memory configured for transmitting signals the image capture device 10. In aspects, the position correction device 40 can be communicably coupled via a communication network (e.g., Wi-Fi Internet connection, L Band satellite connection, or mobile data network) to a computer (e.g., a NTRIP caster computer/server computer) configured to send or broadcast position error correction data to the geographic position error correction device. It is possible that position of the image capture device 10 can be determined within an accuracy of less than 5 cm when utilizing the position correction device 40, which results in improved conversion of the 2D images to the 3D images for projection in the observed headset 3D space of the medial professional wearing the mixed reality headset 20.

FIG. 2 illustrates a method 200 performed by the image capture device 10.

At block 210 the method 200 can include establishing, by the image capture device 10, the patient 3D space. In some aspects, establishing comprises moving the image capture device 10 to define the patient 3D space that contains the patient. In additional aspects, a patient 3D coordinate system is then applied by the image capture device 10 to the patient 3D space. The device positional data that is collected can then include a location of the image capture device 10 relative to the patient 3D space that is defined by a coordinate in the patient 3D coordinate system. In aspects, a location is determined for every 2D image captured by the image capture device 10. In aspects, block 210 is performed prior to the capturing performed at block 220.

At block 220, the method 200 can include capturing, in real-time by the image capture device 10, 2D images of the patient.

At block 230, the method 200 can include determining device positional data of the image capture device 10 corresponding to each of the captured 2D images. In aspects, the device positional data is defined relative to the patient 3D coordinate system in the patient 3D space.

At block 240, the method 200 can include encoding the captured 2D images and the device positional data into an encoded data stream. Encoding can include receiving a stream of tracking data from the tracking module and a stream of 2D images from the video module of the image capture device 10, and encoding the received stream of 2D images and the received stream of tracking data into an encoded data file/stream/packet. For example, encoding can include compressing and attaching the relevant positional data to each of the 2D images, and sending the encoded data/stream/packet (e.g., encoded data, encoded data stream, encoded data packet) to the input/output 16 of the image capture device 10. In aspects, the encoded data can be sent to the input/output 16 in form of an encoded data stream that is continuously streamed from the encoder 15 to the input/output 16. In aspects, the format of the encoded data/stream/packet can be key-length-value (KLV) format.

At block 250, the method 200 can include transmitting, in real-time by the image capture device 10 to the mixed reality headset 20, the encoded data stream. Transmitting can be embodied as real-time streaming. The encoded data stream can also include audio. Prior to transmitting, the image capture device 10 and the mixed reality headset 20 establish a two-way live stream connection via the network 30. The encoded data stream is transmitted via the two-way live stream connection established between the image capture device 10 and the mixed reality headset 20.

At block 260, the method 200 can include receiving, by the image capture device 10 from the mixed reality headset 20, a triage determination. Receiving the triage determination is performed after transmitting the encoded data stream, or simultaneously with transmitting the encoded data stream. The triage determination is transmitted via the two-way live stream connection established between the image capture device 10 and the mixed reality headset 20. The triage determination is a determination of the condition of the patient, such as non-emergency or emergency.

In aspects of the method 200, the mixed reality headset 20 is in a first geographic location, the image capture device 10 is in a second geographic location, and the first geographic location is remote relative to the second geographic location. “Remote” when used with reference to location means that the mixed reality headset 20 is not at the same location as the patient, thus necessitating use of a remotely located medical professional. Thus, the triage determination is made remotely by a medical professional wearing the mixed reality headset 20 and viewing the 3D detail of the images on the mixed reality headset 20.

In aspects of the method 200, the scale of the patient 3D coordinate system in the patient 3D space is determined based on the geographic location of the image capture device 20 at each of a plurality of nodes that are used to define the patient 3D space. The nodes are discussed in more detail herein.

In aspects of the method 200, the scale of the headset 3D coordinate system in the headset 3D space is set based on the scale of the patient 3D coordinate system.

In aspects, the method 200 can also include receiving, by the image capture device 10 from a position correction device 40 prior to capturing, position correctional data. The method 200 can further include applying, by the image capture device 10 prior to capturing, a correction to the device geographic position of the image capture device 10 at each of the first plurality of nodes that define the patient 3D space based on the position correctional data. Applying the correction can determine the position of the image capture device 10 within an accuracy of less than 5 cm, which results in improved conversion of the 2D images to the 3D images for projection in the observed headset 3D space of the medial professional wearing the mixed reality headset 20.

The disclosed method 200 improves medical triage of a patient (e.g., on a worksite) because the condition of the patient can be assessed remotely in 3D detail in real-time because the image capture device 10 builds the patient 3D space and then streams encoded data stream containing captured 2D images and device positional data that is used by the mixed reality headset 20 to view the patient in 3D detail while the devices 10 and 20 are at two separate (remote) geographic locations, avoiding misdiagnosis that could occur if 3D detail were otherwise not utilized in the remote triage. The 3D detail of the images that can be rendered on the mixed reality headset 20 as a result of how the image capture device 10 encodes and transmits the encoded data stream can reduce likelihood that the severity of a patient condition is unrecognized and can reduce likelihood that a patient is subsequently sent to emergency care for a non-emergency condition.

FIG. 3 illustrates a method 300 performed by the mixed reality headset 20. The terms used in the method 200 can have the same meaning when described for method 300, and vice versa.

At block 310, the method 300 can include establishing the headset 3D space. In aspects, establishing can include moving the mixed reality headset 20 to define the headset 3D space. In aspects, a headset 3D coordinate system is then applied by the mixed reality headset 20 to the headset 3D space.

At block 320, the method 300 can include receiving, by the mixed reality headset 20 from the image capture device 10, the encoded data stream from the image capture device 10. As described for the method 200, in method 300 the encoded data stream comprises the 2D images of the patient and the device positional data of the image capture device 10 for each of the 2D images.

At block 330, the method 300 can include converting, in real-time by the mixed reality headset 20, the 2D images to 3D images. The 3D images can be in a live image stream having pixels set at coordinates in the headset 3D coordinate system of the headset 3D space.

At block 340, the method 300 can include converting, in real-time by the mixed reality headset 20, the device positional data for the image capture device 10 received in the encoded data stream into headset positional data for the mixed reality headset 20. In aspects, the headset positional data is defined relative to the headset 3D coordinate system in the headset 3D space. Converting can include separating the device positional data from the encoded data stream, and transforming the device positional data into headset positional data having locations (e.g., coordinates) in the headset 3D coordinate system.

At block 350, the method 300 can include projecting, in real-time by the mixed reality headset 20, a holographic representation of the 3D images in a headset 3D space based on the headset positional data. The holographic representation is a live holographic projection of the 3D images received via the two-way live stream connection between the image capture device 10 and the mixed reality headset 20.

At block 360, the method 300 can include sending, in real-time by the mixed reality headset 20 to the image capture device 10, a triage determination. The triage determination is made by a medical professional wearing the mixed reality headset 20 during the two-way live stream between the image capture device 10 and the mixed reality headset 20. The triage determination can be communicated as a data packet comprising audio or video of the triage determination. The medial professional triages, in real-time using the mixed reality headset 20, the patient to generate the triage determination.

In aspects of the method 300, the mixed reality headset 20 is in a first geographic location, the image capture device 10 is in a second geographic location, and the first geographic location is remote relative to the second geographic location. “Remote” when used with reference to location means that the mixed reality headset 20 is not at the same location as the patient, thus necessitating use of a remotely located medical professional. Thus, the triage determination is made remotely by a medical professional wearing the mixed reality headset 20 and viewing the 3D detail of the images on the mixed reality headset 20.

In aspects of the method 300, the scale of the headset 3D coordinate system in the headset 3D space is set based on the scale of the patient 3D coordinate system.

The disclosed method 300 improves medical triage of a patient (e.g., on a worksite) because the condition of the patient can be assessed remotely in 3D detail in real-time because the mixed reality headset 20 renders a holographic representation of 3D images from the received encoded data stream containing captured 2D images and device positional data, displaying the patient in 3D detail while the 10 and 20 are at two separate (remote) geographic locations, avoiding misdiagnosis that could occur if 3D detail were otherwise not utilized in the remote triage. The 3D detail of the images that can be rendered on the mixed reality headset 20 as a result of receiving the encoded data stream can reduce likelihood that the severity of a patient condition is unrecognized and can reduce likelihood that a patient is subsequently sent to emergency care for a non-emergency condition.

The patient 3D coordinate system and the headset 3D coordinate system can be embodied as a 3D Cartesian coordinate system that uses one or more numbers to determine the position of points or locations through coordinates (e.g., X, Y, Z coordinate) of the image capture device 10 and the mixed reality headset 20 within the respective 3D coordinate system.

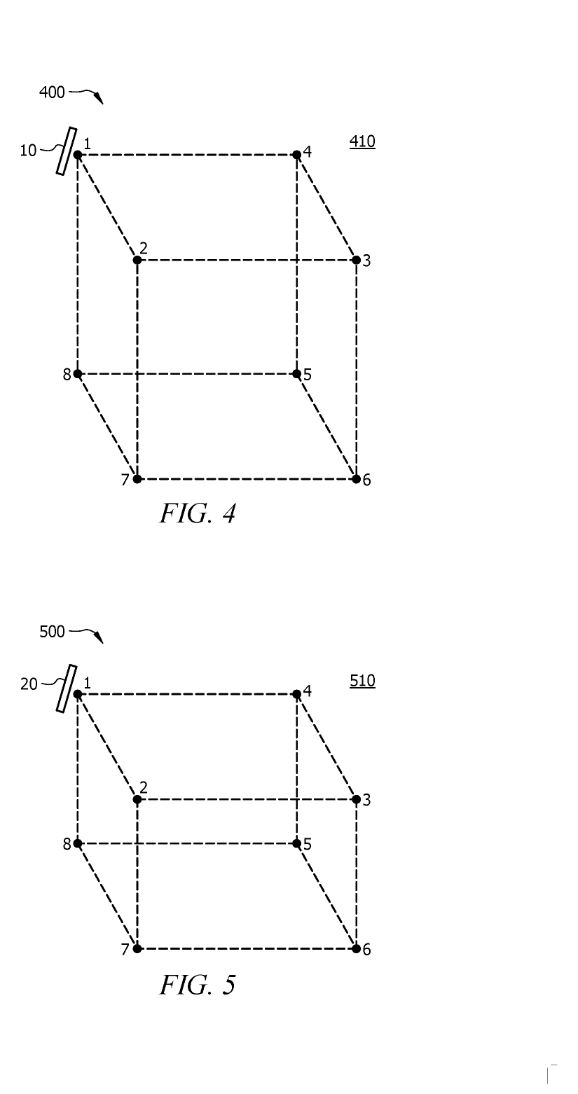

FIG. 4 illustrates a patient 3D space 400 established using the image capture device 10. The patient 3D space 400 is located at geographic location 410. The geographic location 410 in FIG. 4 is remote form the geographic location 510 in FIG. 5.

Nodes 1, 2, 3, 4, 5, 6, 7, and 8 are utilized to form the patient 3D space 400. The number of nodes utilized within scope of this disclosure can be more or fewer than 8, and 8 is exemplary. Moreover the shape of the patient 3D space 400 as a cube in FIG. 4 is also exemplary. It is contemplated that the shape of the patient 3D space 400 can be any shape, regular or irregular. The method 200 describes that establishing the patient 3D space 400 can include moving the image capture device 10 to define the patient 3D space 400 that contains the patient. Defining the patient 3D space can include, by example in FIG. 4, positioning the image capture device 10 at node 1, determining the device positional data at node 1 (e.g., via input to the device 10 such as tough screen input), moving the image capture device 10 from node 1 to node 2, determining the device positional data at node 2 (e.g., via input to the device 10 such as tough screen input), moving the image capture device 10 from node 2 to node 3, determining the device positional data at node 3 (e.g., via input to the device 10 such as tough screen input), moving the image capture device 10 from node 3 to node 4, determining the device positional data at node 4 (e.g., via input to the device 10 such as tough screen input), moving the image capture device 10 from node 4 to node 5, determining the device positional data at node 5 (e.g., via input to the device 10 such as tough screen input), moving the image capture device 10 from node 5 to node 6, determining the device positional data at node 6 (e.g., via input to the device 10 such as tough screen input), moving the image capture device 10 from node 6 to node 7, determining the device positional data at node 7 (e.g., via input to the device 10 such as tough screen input), moving the image capture device 10 from node 7 to node 8, determining the device positional data at node 8 (e.g., via input to the device 10 such as tough screen input). The patient 3D space 400 can be the volume of space surrounded by the nodes 1, 2, 3, 4, 5, 6, 7, and 8.

FIG. 5 illustrates a headset 3D space 500 established using the mixed reality headset 20. The headset 3D space 500 is located at geographic location 510. The geographic location 510 in FIG. 5 is remote from the geographic location 410 in FIG. 4.

Nodes 1, 2, 3, 4, 5, 6, 7, and 8 are utilized to form the headset 3D space 500. The number of nodes utilized within scope of this disclosure can be more or fewer than 8, and 8 is exemplary. Moreover the shape of the headset 3D space 500 as a cube in FIG. 5 is also exemplary. It is contemplated that the shape of the headset 3D space 500 can be any shape, regular or irregular. The method 300 describes that establishing the headset 3D space 500 can include moving the mixed reality headset 20 to define the headset 3D space 500. Defining the headset 3D space can include, by example in FIG. 5, positioning the mixed reality headset 20 at node 1, determining the headset positional data at node 1 (e.g., via input to the headset 20 such as tough screen input), moving the mixed reality headset 20 from node 1 to node 2, determining the headset positional data at node 2 (e.g., via input to the headset 20 such as tough screen input), moving the mixed reality headset 20 from node 2 to node 3, determining the headset positional data at node 3 (e.g., via input to the headset 20 such as tough screen input), moving the mixed reality headset 20 from node 3 to node 4, determining the headset positional data at node 4 (e.g., via input to the headset 20 such as tough screen input), moving the mixed reality headset 20 from node 4 to node 5, determining the headset positional data at node 5 (e.g., via input to the headset 20 such as tough screen input), moving the mixed reality headset 20 from node 5 to node 6, determining the headset positional data at node 6 (e.g., via input to the headset 20 such as tough screen input), moving the mixed reality headset 20 from node 6 to node 7, determining the headset positional data at node 7 (e.g., via input to the headset 20 such as tough screen input), moving the mixed reality headset 20 from node 7 to node 8, determining the headset positional data at node 8 (e.g., via input to the headset 20 such as tough screen input). The headset 3D space 500 can be the volume of space surrounded by the nodes 1, 2, 3, 4, 5, 6, 7, and 8.

### ADDITIONAL DESCRIPTION

Aspect 1. A streaming triage system comprising: an image capture device; and a mixed reality headset networked in a two-way live stream with the image capture device, wherein the image capture device: captures, in real-time, 2D images of a patient; determines, in real-time with capture, device positional data of the image capture device for each of the 2D images; encodes, in real-time, the 2D images and the device positional data into an encoded data stream; transmits, in real-time to the mixed reality headset, the encoded data stream; and receives, in real-time from the mixed reality headset, a triage determination; wherein the mixed reality headset: receives, in real-time from the image capture device, the encoded data stream; converts, in real-time, the 2D images received in the encoded data stream to 3D images; converts, in real-time, the device positional data for the image capture device received in the encoded data stream into headset positional data for the mixed reality headset; projects, in real-time, a holographic representation of the 3D images in a headset 3D space based on the headset positional data; and sends, in real-time to the image capture device, a triage determination; and wherein the patient is triaged by a medical professional wearing the mixed reality headset in real-time.

Aspect 2. The streaming triage system of Aspect 1, wherein the mixed reality headset is in a first geographic location, wherein the image capture device is in a second geographic location, wherein the first geographic location is remote relative to the second geographic location.

Aspect 3. The streaming triage system of Aspect 1 or 2, wherein the mixed reality headset establishes the headset 3D space prior to receiving the encoded data stream.

Aspect 4. The streaming triage system of any of the preceding Aspects, wherein the image capture device establishes a patient 3D space prior to capturing the 2D images and prior to determining the device positional data.

Aspect 5. The streaming triage system of any of the preceding Aspects, wherein the device positional data is defined relative to a patient 3D coordinate system in the patient 3D space, wherein the headset positional data is defined relative to a headset 3D coordinate system in the headset 3D space.

Aspect 6. The streaming triage system of any of the preceding Aspects, wherein the image capture device: receives from a position correction device prior to capturing, position correctional data; and applies, prior to capturing, a correction to a geographic position of the image capture device at each of a first plurality of nodes that define a patient 3D space based on the position correctional data.

Aspect 7. A method comprising: receiving, by a mixed reality headset from an image capture device, an encoded data stream, wherein the encoded data stream comprises 2D images of a patient and a device positional data of the image capture device for each of the 2D images; converting, in real-time by the mixed reality headset, the 2D images received in the encoded data stream to 3D images; converting, in real-time by the mixed reality headset, the device positional data for the image capture device received in the encoded data stream into headset positional data for the mixed reality headset, wherein the headset positional data is defined relative to a headset 3D coordinate system in a headset 3D space; projecting, in real-time by the mixed reality headset, a holographic representation of the 3D images in the headset 3D space based on the headset positional data; and sending, in real-time by the mixed reality headset, a triage determination to the image capture device.

Aspect 8. The method of Aspect 7, wherein the mixed reality headset is in a first geographic location, wherein the image capture device is in a second geographic location, wherein the first geographic location is remote relative to the second geographic location.

Aspect 9. The method of Aspect 7 or 8, further comprising: establishing, by the mixed reality headset prior to receiving, the headset 3D space.

Aspect 10. The method of Aspect 9, wherein establishing comprises: moving the mixed reality headset to define the headset 3D space; and applying the headset 3D coordinate system to the headset 3D space.

Aspect 11. The method of any of the preceding Aspects, wherein the device positional data of the image capture device is defined relative to a patient 3D coordinate system in a patient 3D space.

Aspect 12. The method of Aspect 11, wherein a headset scale of the headset 3D coordinate system in the headset 3D space is set based on a device scale of the patient 3D coordinate system.

Aspect 13. The method of any of the preceding Aspects, wherein the encoded data stream further comprises audio, the method further comprising: prior to converting the 2D images, separating the 2D images from the encoded data stream.

Aspect 14. A method comprising: capturing, in real-time by an image capture device, 2D images of a patient; determining, in real-time by the image capture device, a device positional data of the image capture device corresponding to each of the 2D images, wherein the device positional data is defined relative to a patient 3D coordinate system in a patient 3D space; encoding, in real-time by the image capture device, the 2D images and the device positional data into an encoded data stream; transmitting, in real-time by the image capture device to a mixed reality headset, the encoded data stream comprising the 2D images of the patient and the device positional data of the image capture device for each of the 2D images; and receiving, by the image capture device from the mixed reality headset, a triage determination.

Aspect 15. The method of Aspect 14, wherein the mixed reality headset is in a first geographic location, wherein the image capture device is in a second geographic location, wherein the first geographic location is remote relative to the second geographic location.

Aspect 16. The method of Aspect 14 or 15, further comprising: establishing, by the image capture device prior to capturing, the patient 3D space.

Aspect 17. The method of Aspect 16, wherein establishing comprises: moving the image capture device to define the patient 3D space that contains the patient; and applying the patient 3D coordinate system to the patient 3D space.

Aspect 18. The method of Aspect 17, wherein a device scale of the patient 3D coordinate system in the patient 3D space is determined based on a device geographic position of the image capture device at each of a first plurality of nodes that define the patient 3D space.

Aspect 19. The method of Aspect 18, wherein a headset scale of a headset 3D coordinate system in a headset 3D space is set based on the device scale of the patient 3D coordinate system.

Aspect 20. The method of Aspect 16, 17 , or 18, further comprising: receiving, by the image capture device from a position correction device prior to capturing, position correctional data; and applying, by the image capture device prior to capturing, a correction to the device geographic position of the image capture device at each of the first plurality of nodes that define the patient 3D space based on the position correctional data.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A streaming triage system comprising:
an image capture device; and
a mixed reality headset networked in a two-way live stream with the image capture device,
wherein the image capture device:
captures, in real-time, 2D images of a patient; determines, in real-time with capture, device positional data of the image capture device for each of the 2D images; encodes, in real-time, the 2D images and the device positional data into an encoded data stream; transmits, in real-time to the mixed reality headset, the encoded data stream; and receives, in real-time from the mixed reality headset, a triage determination;
wherein the mixed reality headset:
receives, in real-time from the image capture device, the encoded data stream; converts, in real-time, the 2D images received in the encoded data stream to 3D images; converts, in real-time, the device positional data for the image capture device received in the encoded data stream into headset positional data for the mixed reality headset; projects, in real-time, a holographic representation of the 3D images in a headset 3D space based on the headset positional data; and sends, in real-time to the image capture device, a triage determination; and
wherein the patient is triaged by a medical professional wearing the mixed reality headset in real-time.

2. The streaming triage system of claim 1, wherein the mixed reality headset is in a first geographic location, wherein the image capture device is in a second geographic location, wherein the first geographic location is remote relative to the second geographic location.

3. The streaming triage system of claim 1, wherein the mixed reality headset establishes the headset 3D space prior to receiving the encoded data stream.

4. The streaming triage system of claim 1, wherein the image capture device establishes a patient 3D space prior to capturing the 2D images and prior to determining the device positional data.

5. The streaming triage system of claim 4, wherein the device positional data is defined relative to a patient 3D coordinate system in the patient 3D space, wherein the headset positional data is defined relative to a headset 3D coordinate system in the headset 3D space.

6. The streaming triage system of claim 1, wherein the image capture device:
receives from a position correction device prior to capturing, position correctional data; and
applies, prior to capturing, a correction to a geographic position of the image capture device at each of a first plurality of nodes that define a patient 3D space based on the position correctional data.

7. A method comprising:
capturing, in real-time by an image capture device, 2D images of a patient;
determining, in real-time by the image capture device, a device positional data of the image capture device corresponding to each of the 2D images, wherein the device positional data is defined relative to a patient 3D coordinate system in a patient 3D space;
encoding, in real-time by the image capture device, the 2D images and the device positional data into an encoded data stream;
transmitting, in real-time by the image capture device to a mixed reality headset, the encoded data stream comprising the 2D images of the patient and the device positional data of the image capture device for each of the 2D images; and
receiving, by the image capture device from the mixed reality headset, a triage determination.

8. The method of claim 7, wherein the mixed reality headset is in a first geographic location, wherein the image capture device is in a second geographic location, wherein the first geographic location is remote relative to the second geographic location.

9. The method of claim 7, further comprising:
establishing, by the image capture device prior to capturing, the patient 3D space.

10. The method of claim 9, wherein establishing comprises:
moving the image capture device to define the patient 3D space that contains the patient; and
applying the patient 3D coordinate system to the patient 3D space.

11. The method of claim 10, wherein a device scale of the patient 3D coordinate system in the patient 3D space is determined based on a device geographic position of the image capture device at each of a first plurality of nodes that define the patient 3D space.

12. The method of claim 11, wherein a headset scale of a headset 3D coordinate system in a headset 3D space is set based on the device scale of the patient 3D coordinate system.

13. The method of claim 11, further comprising:
receiving, by the image capture device from a position correction device prior to capturing, position correctional data; and
applying, by the image capture device prior to capturing, a correction to the device geographic position of the image capture device at each of the first plurality of nodes that define the patient 3D space based on the position correctional data.

14. A method comprising:
receiving, by a mixed reality headset from an image capture device, an encoded data stream, wherein the encoded data stream comprises 2D images of a patient and a device positional data of the image capture device for each of the 2D images;
converting, in real-time by the mixed reality headset, the 2D images received in the encoded data stream to 3D images;
converting, in real-time by the mixed reality headset, the device positional data for the image capture device received in the encoded data stream into headset positional data for the mixed reality headset, wherein the headset positional data is defined relative to a headset 3D coordinate system in a headset 3D space;
projecting, in real-time by the mixed reality headset, a holographic representation of the 3D images in the headset 3D space based on the headset positional data; and
sending, in real-time by the mixed reality headset, a triage determination to the image capture device.

15. The method of claim 14, wherein the mixed reality headset is in a first geographic location, wherein the image capture device is in a second geographic location, wherein the first geographic location is remote relative to the second geographic location.

16. The method of claim 14, further comprising:
establishing, by the mixed reality headset prior to receiving, the headset 3D space.

17. The method of claim 16, wherein establishing comprises:
moving the mixed reality headset to define the headset 3D space; and
applying the headset 3D coordinate system to the headset 3D space.

18. The method of claim 14, wherein the device positional data of the image capture device is defined relative to a patient 3D coordinate system in a patient 3D space.

19. The method of claim 18, wherein a headset scale of the headset 3D coordinate system in the headset 3D space is set based on a device scale of the patient 3D coordinate system.

20. The method of claim 14, wherein the encoded data stream further comprises audio, the method further comprising:
prior to converting the 2D images, separating the 2D images from the encoded data stream.
